(19) United States
(12) Patent Application Publication
(10) Pub. No.: US 2012/0154160 A1
(43) Pub. Date: Jun. 21, 2012

(54) METHOD AND SYSTEM FOR CONFIGURING FIRE ALARM DEVICE GROUPINGS AT THE FIRE ALARM DEVICE

(76) Inventor: Joseph Piccolo, III, Fitzwilliam, NH (US)

(21) Appl. No.: 12/970,035

(22) Filed: Dec. 16, 2010

(51) Int. Cl. G08B 17/10; G08B 5/22

(52) U.S. Cl. 340/628; 340/6.1

(57) ABSTRACT

A notification appliance that communicates with a fire alarm control panel is provided. The notification appliance includes a grouping input device that is configured to receive operator input grouping information (such as a manual input from the operator). The operator input grouping information may be indicative of at least one grouping for the notification appliance in the fire alarm system, such as a type of grouping (e.g., “mass notification” or “fire alarm notification”) or a number indicative of a grouping (e.g., in a system with groupings from 1 to 8, the number may be selected from 1 to 8). The grouping input device may be a switch (such as an electromechanical switch), a jumper, a dial (or other movable control knob), or other manual input device. Or, the grouping input device may comprise a device which is configured to receive a wireless input from the operator. In this way, the grouping of the notification appliance may be configured at the notification appliance itself, rather than require programming at the fire alarm control panel.

### BACKGROUND

Typical fire alarm systems include a number of fire alarm system devices, such as fire detectors (including smoke, flame and heat detectors and the like), pullstations, notification appliances, etc., positioned throughout a building (and/or campus). Signals from those fire alarm system devices are monitored by a system controller, such as a fire alarm control panel (“FACP”). The FACP, upon sensing an alarm condition, sends commands to one or more notification appliances to alert occupants in one section of the building, in multiple sections of the building, or in all sections of the building. Notification appliances can output a visual notification, an audible notification, or both. Examples of notification appliances include, but are not limited to strobes, horns, speakers, and the like. Notification appliances are typically connected across common power lines on a notification appliance circuit (“NAC”).

The fire alarm system may further include mass notification/emergency communication (MNEC) functionality. Unexpected emergency situations (such as a terrorist threat or an oncoming tornado) may require real-time widespread mass notification. Notification appliances within the fire alarm system, termed mass notification appliances, may be used for the widespread mass notification.

Prior fire alarm systems with MNEC functionality have used different ways in which to integrate the mass notification appliances within the fire alarm system. One way is to configure the mass notification appliances on wiring that is separate from fire alarm notification appliances. More specifically, in a non-addressable fire alarm system, the fire alarm control panel may activate the mass notification appliances by sending a command on the separate wiring. Another way, used in an addressable fire alarm system, is to configure the fire alarm control panel to recognize the different notification devices as either a mass notification device or a fire alarm notification device. Either solution has its advantages and disadvantages. Using separate wiring for the mass notification appliances requires less configuration of the fire alarm panel at the expense of the extra wiring. Configuring the fire alarm control panel removes the need for extra wiring at the expense of additional configuration of the fire alarm control panel. Thus, a need exists to better configure a fire alarm system with integrated MNEC functionality.

### SUMMARY

The present embodiments relate to methods and systems for configuring fire alarm system devices in a fire alarm system. In one aspect, a notification appliance that communicates with a fire alarm control panel is provided. The notification appliance includes a grouping input device that is configured to receive operator input grouping information (such as a manual input from the operator). The operator input grouping information may be indicative of at least one grouping for the notification appliance in the fire alarm system, such as a type of grouping (e.g., “mass notification” or “fire alarm notification”) or a number indicative of a grouping (e.g., in a system with groupings from 1 to 8, the number may be selected from 1 to 8). The grouping input device may be a switch (such as an electromechanical switch), a jumper, a dial (or other movable control knob), or other manual input device. Or, the grouping input device may comprise a device which is configured to receive a wireless input from the operator.

The notification appliance may further include a communications interface configured to communicate with a fire alarm control panel in a fire alarm system, a memory configured to store the operator input grouping information, and a controller. The communications interface may receive a command from the fire alarm control panel, and the controller may be configured to parse the command for command grouping information, determine whether to execute the command based on the parsed command grouping information and on the stored operator input grouping information and in response to determining to execute the command, execute the command. Or, the communications interface may receive a grouping request from the fire alarm panel, the grouping request indicative of requesting grouping information of the fire alarm notification device. In response to receiving the grouping request, the controller may be configured to send the operator input grouping information to the fire alarm control panel.

In another aspect, a fire alarm control panel that communicates with one or more notification appliances is provided. The fire alarm control panel includes at least one communications interface, a memory, and a controller. The controller is configured to: send to one or more notification appliances, via the at least one communications interface, a grouping request indicative of requesting grouping information from the one or more notification appliances; receive a response, via the at least one communications interface, from the one or more notification appliances; parse the response for grouping information, the grouping information indicative of one or more groupings for the one or more notification appliances in the fire alarm system; and store the grouping information in the memory.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a schematic diagram illustrating a fire alarm system.

FIG. 2 is a schematic diagram of the system of FIG. 1, further illustrating details of an embodiment of the present invention.

FIG. 3 is an example of a flow chart in which a command a fire alarm system device is configured.

### DETAILED DESCRIPTION

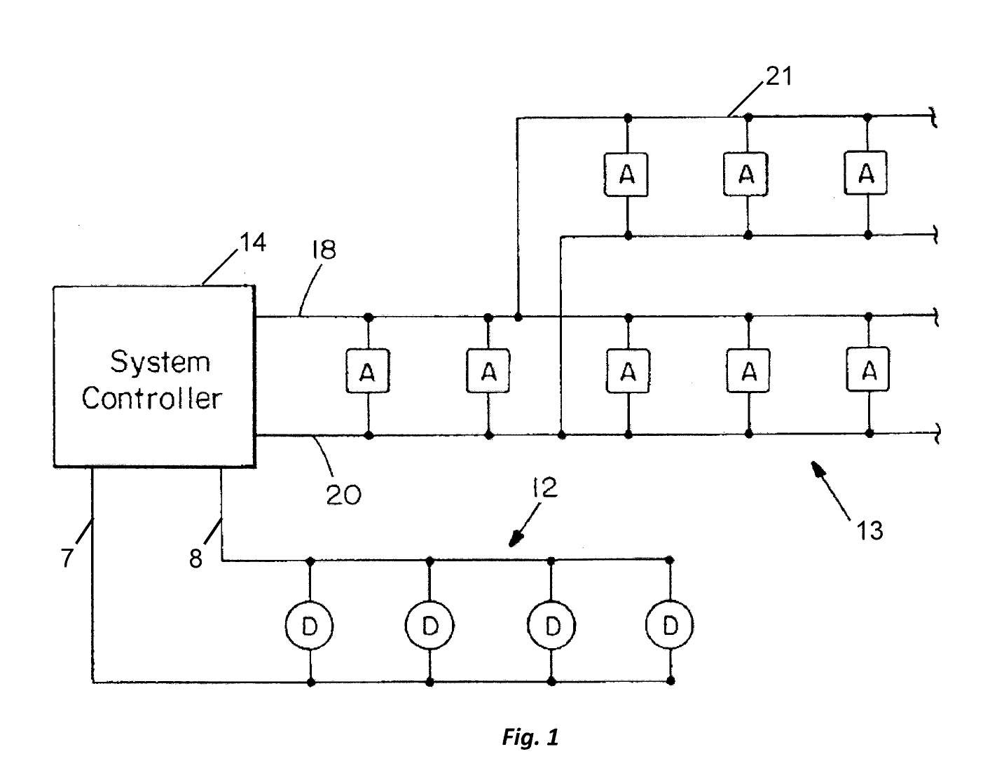

A system embodying one example of the present invention is illustrated in FIG. 1. The system includes a system controller 14 (such as a fire alarm control panel (FACP)), alarm condition detectors D, and alarm system notification appliances A. The system may be configured in different ways, such as depicted in FIG. 1.

FIG. 1 further depicts one appliance circuit 13. Alternatively, more than one appliance circuit may be used in the alarm system. FIG. 1 further depicts one detector circuit 12. Alternatively, more than one detector circuit may be used in the alarm system. The appliance circuit 13 and the detector circuit 12 include one or more wires (such as 7 and 8, 18 and 20) that emanate from the system controller 14.

The example in FIG. 1 depicts that all of the notification devices are coupled across a pair of power lines 18 and 20, although this is not necessary for carrying out the invention. Lines 18 and 20 may carry communications between the system controller 14 and the notification devices A on appliance circuit 13. Lines 6 and 7 may carry communications between the system controller 14 and detectors D on detector circuit 12.

The appliance circuits may have alarm condition detectors D, alarm system notification appliances A, or both alarm condition detectors D and alarm system notification appliances A. For example, FIG. 1 depicts detector circuit (DC) 12 that includes alarm condition detectors A. As still another example, FIG. 1 depicts notification appliance circuit (NAC) 13 that includes alarm system notification appliances A. As still another example, the alarm system may include a detector/notification appliance circuit (D/NAC) that includes both alarm condition detectors D and alarm system notification appliances A. Again, FIG. 1 is merely for illustration purposes. Fewer or greater numbers of appliance circuits may be used, fewer or greater NACs may be used, fewer or greater DCs may be used, and, one or multiple D/NACs may be used.

The system may further include one or more single-ended stub circuits 21, such as shown in FIG. 1. The use of stub circuits 21, also referred to as “T-tapping”, provides a number of advantages, reducing the wire material and installation costs, and allowing for increased NAC wiring distances.

The system controller 14 may monitor the alarm condition detectors D. When an alarm condition is sensed, the system controller 14 may signal the alarm to the appropriate notification appliances A through the one or more appliance circuits. Notification devices may include, for example, a visual alarm (such as a strobe), an audible alarm (such as a horn), or any combination thereof. The examples of the strobe and the horn are provided merely for illustration purposes. Other notification appliances are contemplated. Moreover, a visible indicator (such as an LED) may be provided on any of the above-described notification appliances A, with the LED also being controlled by the system controller 14. For example, the LED may be operated under NAC commands (described below) such that the LED blinks every time the notification appliance A is polled.

The system controller 14 may use one or more commands to signal the alarm to the appropriate notification appliances A. Examples of commands issued for a system with addressable notification appliances are disclosed in U.S. Pat. No. 6,426,697, which is hereby incorporated by reference in its entirety. Further, the system controller 14 may send one or more commands relating to diagnostics, status, or other non-alarm type events. For example the system controller 14 may send a command related to the identification, the configuration, and/or the status of the notification appliances A. And, the notification appliances A may respond in kind. Alternatively, the communication line to the alarm condition detectors D and/or may notification appliances A be separate from the power line. The communications channel may comprise, for example, a wireless link, a wired link or a fiber optic link.

The notification appliances A are typically grouped into one or more categories. Examples of groupings may include: all notification appliances, all fire alarm notification appliances, all mass notification appliances, all audible appliances, all strobe appliances, all notification appliances in a particular area (such as a particular floor of a building), etc. The groupings may be part of a “hard-coded” grouping, in which the grouping is set upon manufacture, or may be part of a “customized” grouping, in which the grouping may be programmed after manufacture.

As discussed in more detail below, the notification appliances are configured to accept operator input at the notification appliance that designates membership in or association with one or more groupings for the notification appliance. The operator input grouping(s) may then be used during operation of the fire alarm system, such as at the fire alarm panel and/or at the notification appliances. With respect to the notification appliances, the operator input grouping(s) may be stored at the notification appliance for later use by the notification appliance A. For example, the fire alarm panel may issue a command, with the command including a particular grouping. Upon receipt of the command, the notification appliance A may examine the command in order to determine whether to execute the command (e.g., if the command includes a grouping that matches one of the operator input grouping(s), the command is executed).

The command may include a particular field that indicates the grouping. In one example, the particular field may include information indicative of “all mass notification appliances”. The information that indicates “all mass notification appliances” may be a numeral (such as “4”), a letter, or the like. The notification appliance A may review the grouping field in the command to determine whether the notification appliance has been classified with the particular grouping. In the example of the command indicative of “all mass notification devices”, if the notification appliance A was configured to be grouped as a mass notification appliance, the notification appliance will execute the command.

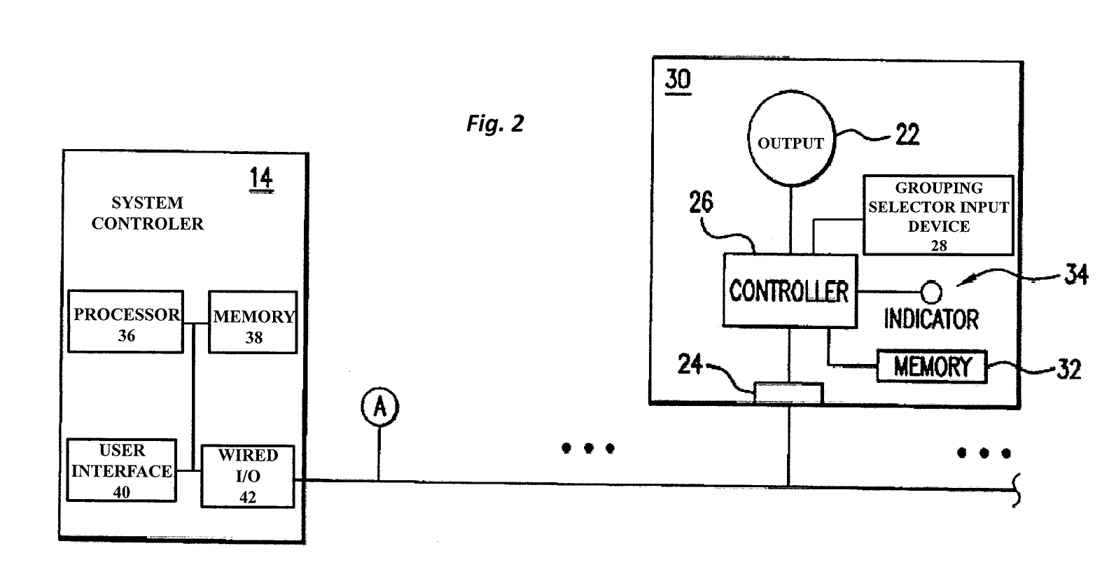

FIG. 2 is a schematic diagram of the system of FIG. 1, using a general example of a notification appliance 30. As discussed above, the notification appliance may include strobe, speaker, horn, or the like. These examples of the notification appliances A are merely for illustration purposes only. Other notification appliances A may be used. For simplicity, the two-line network of FIG. 1 is shown with a single line. Communication signals to and from the fire alarm control panel 14 may be multiplexed onto the device's power line, as discussed above. Alternatively, communications signals may be on a communication line that is separate from the power line. For example, a fiber optic cable link or a wireless connection can be utilized. Alternatively, or in addition, the notification appliance 30 may directly communicate with the fire alarm control panel 14 using for example, optical signaling (for example, an LED, an infrared emitter, etc.). The notification appliance 30 may also communicate using other means, such as RF tag reading or audio (e.g., ultrasonic, chirps, beeps, prerecorded or synthesized voice, etc.)

The fire alarm control panel 14 includes a processor 36, a memory, 38, a user interface 40, and wired I/O 42. The wired I/O 42 is configured to be a wired network interface for the notification appliance 30.

Notification appliance 30 comprises a network interface 24, a controller 26, an output 22, a memory 32, an indicator 34, and a grouping select input device 28. The notification appliance 30 connects to the network via the network interface (communication connection) 24. The controller 26, such as a microprocessor, microcontroller or hardwired logic, receives commands from and sends data to the fire alarm control panel 14. For example, the fire alarm control panel 14 may send a command to activate the output 22 of the notification appliance 30. As another example, the fire alarm control panel 14 may send a command to request a response from the notification appliance 30, the response including a request as to the status of part or all of the notification appliance 30. Or, the fire alarm control panel 14 may send a command to configure the notification appliance 30, as discussed in more detail below.

When the notification appliance 30 receives the command to activate the output 22, the output is activated. In the example of the notification appliance comprising a strobe device that includes a strobe, upon activation of the strobe device, the strobe flashes. The strobe may comprise a xenon flash tube or an LED and drive circuitry, or other high-brightness light source. In the example of notification appliance comprising a speaker, upon activation of the speaker, the speaker generates an aural output. In the example of the notification comprising a horn, the horn is activated.

Although shown separately, the memory 32 may be integrated with the controller 26. The indicator 34, such as a flashing LED, may indicate a current configuration of the notification appliance 30, for example, upon command from the fire alarm control panel 14, upon a local manual command such as a pushbutton (not shown), on a periodic basis, always, or upon some other event.

Notification appliance 30 further includes grouping selector input device 28. Grouping selector input device 28 may comprise a device which is configured to receive an input from an operator, such as a manual input from the operator. The input from the operator is indicative of at least one aspect of a grouping for the notification appliance. The aspect of the grouping for the notification appliance may include a type of grouping. For example, the type of grouping may comprise “mass notification” or “fire alarm notification”. The aspect of the grouping for the notification appliance may include a number or a letter indicative of a grouping. For example, the notification appliances may be grouped from 1 to 8, with the number of the grouping (selected from 1 to 8) indicative of a grouping. The examples of the aspect of the grouping are provided merely for illustration purposes. Other aspects of grouping that may be manually input are contemplated.

Grouping selector input device 28 may include a switch (such as an electromechanical switch), a jumper, a dial (or other movable control knob), or other manual input device. The operator may provide a manual input to grouping selector input device 28, such as by setting the switch, moving the dial, or the like. For example, the switch may be a 2-setting switch, with a first setting of the 2-setting switch indicative of “mass notification” and a second setting of the 2-setting switch indicative of “fire alarm notification”. As another example, the dial may include eight different settings, with each of the settings comprising a selection of the number of the grouping from 1 to 8.

Or, grouping selector input device 28 may comprise a device which is configured to receive a wireless input that is initiated by a manual input from the operator. For example, grouping selector input device 28 may include an optical sensor (e.g., an infrared sensor) that is configured to receive an optical input from an operator who is proximate to the notification appliance 30 (such as in a direct line of sight in order to receive an optical input). The operator may provide a wireless input to grouping selector input device 28, such as by sending an infrared signal (such as a Bluetooth signal).

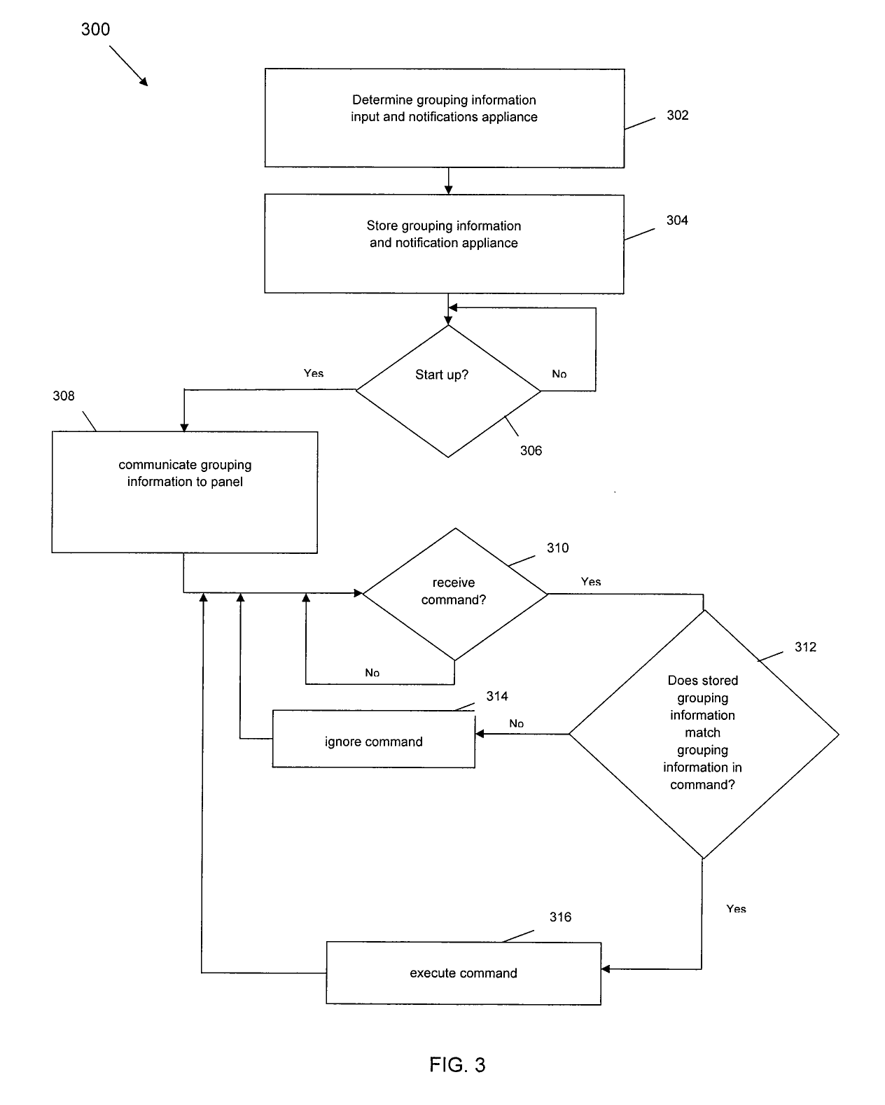

FIG. 3 is an example of a flow chart 300 in which the grouping of the notification appliance is configured. At 302, the notification appliance determines whether grouping information has been input at the notification appliance. As discussed above, different aspects of grouping information may be entered, such as a type of grouping or a number indicative of grouping. At 304, the notification appliance may store the grouping information in the memory 32 of the notification appliance. At 306, the notification appliance may determine whether the fire alarm system is starting up. The notification may make this determination whether startup is occurring in one of several ways. One way is to receive a startup command from the fire alarm control panel. The startup command may include information that indicates to the notification appliance that the fire alarm system is starting up. Another way is for the notification appliance to sense that it has been powered up. Upon power up, the notification appliance may determine that startup is occurring.

At 308, the notification appliance may communicate the grouping information to the fire alarm panel if startup is occurring. The communication from the notification appliance to the fire alarm panel may take one of several forms. For example, the communication may include a field that includes the grouping information.

Apart from (or in addition to) communicating the grouping information upon startup, the notification appliance may communicate the grouping information at other times of operation different from startup. For example, the notification appliance may communicate the grouping information in response to a status request from the fire alarm control panel requesting the grouping information.

At 310, the notification appliance determines if the notification appliance has received a command. If not, the notification appliance loops back and waits to receive a command. If so, at 312, the notification appliance determines whether the grouping information stored at the notification appliance matches the grouping information in the received command. As discussed above, the command may include a field that indicates the grouping intended to act on the command. The controller 26 may determine whether the information in the grouping field of the command matches the stored grouping information. If it matches, the command is executed at 316. If not, the command is ignored at 314.

For example, the fire alarm system may be an addressable system so all of the notification devices are on the same wire, while two separate zone groupings are required (one for fire alarm zones and a second for mass notification zones). The user may select a grouping at each of the notification devices, so that each notification appliance can communicate its selected grouping to the fire alarm control panel. As discussed above, different aspects of grouping information may be entered, such as a type of grouping or a number indicative of grouping. In one example, it is assumed that each notification device can be assigned to a group from 1-8, where groups 1-4 are interpreted as fire notification zones by the fire alarm control panel, and 5-8 are interpreted as mass notification zones by the fire alarm control panel. So for this example, the installer may take each device and select group 1 for all devices that operate as part of fire zone 1, group 2 for all devices that operate as part of fire zone 2, etc. In this example, even though there are four mass notification zones, only one of the mass notification zones for the entire building is needed. So, the installer may select group 5 for all devices that are mass notification devices. In this way, the notification appliance grouping does not require any customization of the fire alarm control panel's configuration. Rather, inputting the indication of the notification appliance grouping is performed at the notification appliance. In a second example, each notification device can be assigned to group “A” or group “B”, with group “A” being interpreted as a fire notification zone and group “B” being interpreted as a mass notification zone. For this example, the installer may thus select group “A” to designate the notification appliance as a fire notification appliance and may thus select group “B” to designate the notification appliance as a mass notification appliance.

While the invention has been described with reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A notification device comprising:
a communications interface configured to receive a command from a fire alarm control panel in a fire alarm system;
a grouping input device configured to receive operator input grouping information, the operator input grouping information indicative of at least one grouping for the notification appliance in the fire alarm system;
a memory configured to store the operator input grouping information; and
a controller configured to:
parse the command for command grouping information;
determine whether to execute the command based on the parsed command grouping information and on the stored operator input grouping information; and
in response to determining to execute the command, execute the command.

2. The fire alarm notification device of claim 1, wherein the grouping input device comprises a manual grouping input device configured to receive a manual input from an operator.

3. The fire alarm notification device of claim 2, wherein the manual grouping input device comprises a switch.

4. The fire alarm notification device of claim 1, wherein the controller is further configured to send the operator input grouping information to the fire alarm control panel.

5. The fire alarm notification device of claim 4, wherein the communications interface further receives a grouping request indicative of requesting grouping information of the fire alarm notification device; and
wherein the controller is configured to send the operator input grouping information to the fire alarm control panel in response to receiving the grouping request.

6. The fire alarm notification device of claim 1, wherein the operator input grouping information is indicative of a mass notification grouping.

7. The fire alarm notification device of claim 1, wherein the grouping input device is configured to receive one of a plurality of inputs, the plurality of inputs indicative of different groupings for a fire alarm zone.

8. A fire alarm control panel comprising:
at least one communications interface;
a memory; and
a controller configured to:
send to at least one notification appliance, via the at least one communications interface, a grouping request indicative of requesting grouping information from the at least one notification appliance;
receive a response, via the at least one communications interface, from the at least one notification appliance;
parse the response for grouping information, the grouping information indicative of at least one grouping for the at least one notification appliance in the fire alarm system; and
store the grouping information in the memory.

9. The fire alarm control panel of claim 8, wherein the grouping request requests whether the at least one notification appliance is a mass notification appliance.

10. The fire alarm control panel of claim 8, wherein the grouping information is one of a plurality of inputs, the plurality of inputs indicative of different groupings for a fire alarm zone.

11. The fire alarm control panel of claim 8, wherein the controller is further configured to automatically include the at least one notification appliance in a group based on the grouping information.

12. A method for operating a notification device, the method comprising:
receiving manual operator input grouping information at the notification device, the operator input grouping information indicative of at least one grouping for the notification appliance in the fire alarm system;
receiving a command from a fire alarm control panel;
parsing the command for command grouping information;
determining whether to execute the command based on the parsed command grouping information and based on the received manual operator input grouping information; and
in response to determining to execute the command, executing the command.

13. The method of claim 12, wherein the notification appliance comprises a grouping selector input device configured to receive a manual input from an operator; and
wherein receiving manual operator input grouping information comprises receiving the manual input from the operator.

14. The method of claim 12, wherein the notification appliance comprises a grouping selector input device configured to receive a wireless input that is initiated by a manual input from an operator; and
wherein receiving manual operator input grouping information comprises receiving the wireless input that is initiated by the manual input from the operator.

15. The method of claim 12, further comprising sending the operator input grouping information to the fire alarm control panel.

16. The method of claim 15, further comprising receiving a grouping request indicative of requesting grouping information of the fire alarm notification device; and
wherein sending the operator input grouping information to the fire alarm control panel is in response to receiving the grouping request.

17. The method of claim 12, wherein the operator input grouping information is indicative of a mass notification grouping.

18. The method of claim 12, wherein the notification appliance receives one of a plurality of inputs, the plurality of inputs indicative of different groupings for a fire alarm zone.
